(19) United States
(12) Patent Application Publication
(10) Pub. No.: US 2024/0053145 A1
(43) Pub. Date: Feb. 15, 2024

(54) DEVICE FOR EMITTING ELECTROMAGNETIC RADIATION AND/OR SOUND WAVES

(71) Applicant: TIPSYCONTROL GMBH, Dargow (DE)

(72) Inventor: Tobias GRAU, HAMBURG (DE)

(21) Appl. No.: 18/259,009

(22) PCT Filed: Dec. 22, 2021
(86) PCT No.: PCT/EP2021/087325

§ 371 Date: Jun. 22, 2023

(30) Foreign Application Priority Data
Dec. 23, 2020 (DE) 10 2020 134 895.9

(51) Int. Cl. G01C 9/04; G01P 15/00

(52) U.S. Cl. CPC G01C 9/04; G01P 15/00

(57) ABSTRACT

A device for emitting electromagnetic radiation and/or sound waves by a corresponding transmitter and a corresponding method, wherein the device includes a control module connected to the transmitter. The control module includes a processor and an inclination sensor. The inclination sensor is electrically connected to the processor. The processor is configured to evaluate an inclination angle or change in inclination angle recorded by the inclination sensor continuously or periodically after each elapsing of a time interval in relation to a movement of the inclination sensor and for controlling the transmitter in an active state, in which the transmitter is switched on, or in a passive state, in which the transmitter is switched off. An intuitive control of the transmitter by means of a tilting movement of the inclination sensor is hereby achieved.

### CROSS-REFERENCES TO RELATED APPLICATIONS

This application claims the benefit of the International Application No. PCT/EP2021/087325, filed on Dec. 22, 2021, and of the German patent application No. 102020134895.9 filed on Dec. 23, 2020, the entire disclosures of which are incorporated herein by way of reference.

### FIELD OF THE INVENTION

The invention relates to a device for emitting electromagnetic radiation and/or sound waves by a corresponding transmitter, a method for controlling such a transmitter and a corresponding control module.

### BACKGROUND OF THE INVENTION

In a device for emitting electromagnetic radiation, for example a lamp, various concepts for switching on and off and for dimming have been implemented so far. A lamp can be switched on or off by means of a mechanical switch, e.g., a toggle switch or a button. More modern options for switching on and off and dimming are designated as touch dimming (switching and dimming by touching the lamp) or gesture control (switching and dimming by predetermined gestures that a person performs near the lamp). However, these more modern switching and dimming methods are error-prone in operation. Analogous means for controlling volume and switching on and off are also known for a sound playback device.

Starting from the known solutions specified above, there is a need to switch or dim a transmitter of such a device without using a mechanical switch for this purpose, since such a switch is frequently perceived to be aesthetically unappealing for the design. In addition, the control of the device should be easy, error-free and safe to handle for the person performing the operation.

### SUMMARY OF THE INVENTION

An object of the present invention is therefore to provide a device specified above and a control module and a method for controlling a transmitter that emits electromagnetic radiation and/or sound waves, which meet the requirements outlined above.

The above object is achieved by a device for emitting electromagnetic radiation and/or sound waves, a control module and a method for controlling a transmitter which emits electromagnetic radiation and/or sound waves.

The device according to the invention for emitting electromagnetic radiation (in particular, in the wavelength range visible to humans, i.e., visible light) and/or sound waves (in particular, in the wavelength range audible to humans) with a transmitter for emitting the electromagnetic radiation and/or the sound waves, in particular, has a control module connected to the transmitter. The control module comprises a processor and an inclination sensor, wherein the inclination sensor is electrically connected to the processor. The processor is adapted in such a manner that it evaluates an angle of inclination and/or a change in the angle of inclination recorded by the inclination sensor continuously or periodically after each elapsing of at least one time interval in relation to a movement of the inclination sensor and uses the angle of inclination and/or a change in the angle of inclination for controlling the transmitter in an active state, in which the transmitter is switched on, or a passive state in which the transmitter is switched off, in such a manner that the processor controls the transmitter when ascertaining a tilting movement of the inclination sensor from a rest position or from a position tilted in relation to the rest position with a first change in inclination angle over a first tilting time interval in such a manner that it goes over from an active state into a setting state, wherein in the setting state at least one setting variable of the transmitter can be changed by the processor in accordance with a predetermined manner of change, or goes over into a further active state, wherein in the further active state the operating mode of the transmitter is changed in relation to at least one setting variable compared to the active state, and
that the processor, when ascertaining a tilting movement of the inclination sensor from the rest position or from the tilted position with a second change in inclination angle over the first tilting time interval, controls the transmitter in such a manner that it goes over from the active state or the further active state into the passive state or from the passive state into the active state, wherein the second change in inclination angle differs from the first change in inclination angle.

In particular, the processor is adapted so that the processor, when ascertaining a slow tilting movement of the inclination sensor from a rest position, controls the transmitter in such a manner that it goes over from an active state to a setting state, wherein in the setting state at least one setting variable of the transmitter can be changed by the processor according to a predetermined manner of change, and
that the processor, when ascertaining a rapid tilting movement of the inclination sensor from the rest position, controls the transmitter in such a manner that it goes over from the active state into a passive state in which the transmitter is switched off, wherein in each case in the first tilting time interval a small change of inclination angle forms a slow tilting movement and a large change of inclination angle forms a rapid tilting movement.

The device can comprise, for example, a lamp and the transmitter can comprise at least one illuminant, wherein the illuminant, for example, comprises at least one LED, fluorescent tube, metal vapor lamp or the like.

Alternatively, the device can be a playback device (e.g., radio, loudspeaker box, MP3 player, smartphone and the like devices for the reproduction of sound/sound waves, wherein the reproduction of images can be included), wherein the transmitter comprises at least one loudspeaker.

The respective transmitter can have a transmitter control which converts the control signals of the processor so that the transmitter with the illuminant and/or the loudspeaker emits the electromagnetic radiation and/or the sound waves in the respectively desired manner. The transmitter can adopt an active state in which the transmitter emits a specific electromagnetic radiation and/or sound waves, i.e., is switched on, a passive state in which the transmitter does not emit any electromagnetic radiation and/or sound waves, i.e., is switched off, or a setting state in which at least one setting variable of the transmitter can be changed according to a predetermined manner of change. Here, the manner of change of the at least one setting variable (e.g., brightness, color temperature, volume) can be predetermined by the processor using appropriate control signals. For example, the processor controls the transmitter control, which sets the transmitter according to the control signals from the processor. The transmitter control has a driver stage and/or an amplifier, for example. The transmitter can also implement further active states in which at least one setting variable has changed compared to the active state. This includes, for example, different, preset brightness states of the illuminants (e.g., only part of a plurality of LEDs or all LEDs of the plurality are switched on) or states in which several different transmitter media (e.g., loudspeakers and illuminants) are used, which are combined differently in terms of their operating mode or possibly their on and off state.

In one exemplary embodiment, the transmitter is arranged in at least one transmitter unit that is spatially separate from the control module, wherein each transmitter unit comprises a transmitter and a housing and/or holder, wherein the transmitter is arranged in the housing and/or on the holder. The transmitter unit(s) is/are, for example, a lamp or several lamps, e.g., wall lights, each having at least one illuminant and/or a playback device or multiple playback devices, a loudspeaker system, each having at least one loudspeaker. The control module with the processor and the inclination sensor can be moved separately from the at least one transmitter unit. The device is therefore designed in at least two parts. The at least one transmitter unit can be controlled with a single but separate control module. For this purpose, the control module is adapted to emit and each transmitter unit is adapted to receive control signals from the processor arranged in the control module via a communication channel, through which the transmitter can be controlled according to the respectively adopted state (e.g., switching on and off, dimming, changing the color temperature of the separate illuminant(s) and/or changing the volume of the separate loudspeakers). To control the at least one transmitter, the control module can carry out the tilting movements as described above and below. The inclination sensor, which is fixedly installed in the control module, can detect these movements and relay corresponding data to the processor. The data is analyzed in the processor and appropriate transitions of the states of the transmitter are brought about on the basis of this analysis. Based on the respective state of the transmitter, the processor communicates (sends) control signals to the transmitter unit to control the transmitter (e.g., at least one illuminant and/or at least one loudspeaker) accordingly. For this purpose, the control module has a corresponding transmitter or transceiver for the communication of the control signals and the transmitter unit has a corresponding receiver or transceiver for the communication of these control signals.

Communication can take place, for example, via Bluetooth, ZigBee (IEE E802.15.4), LoRa/LoRaWAN, NFC (Near Field Communication) or WLAN.

Alternatively, the control module can have a common housing and/or a common holder together with the transmitter and the control module, wherein the transmitter and the control module are arranged in the housing and/or on the holder. Alternatively or additionally, the transmitter and the control module can be integrated with the processor in a single assembly (printed circuit board) or in a single component (chip). In these exemplary embodiments the device forms a single unit with an integrated control module, e.g., in the form of a table lamp or in the form of a table loudspeaker. The control module (with the inclination sensor) together with the transmitter executes the tilting movements defined above and below. The inclination sensor is firmly arranged in the housing together with the control module.

The lamp (with or without a separate control module) can have a housing (also designated as lamp body), inside which the at least one lamp is arranged.

The housing, which is for example translucent or transparent and/or provided with continuous openings, is trans-illuminated by the electromagnetic radiation (light). The housing preferably has a surface that is sealed with respect to moisture. In one exemplary embodiment, the housing is designed in at least two parts, wherein a hollow body and a base plate can be provided, which are fastened to one another. In one exemplary embodiment, the base plate closes the hollow body, for example by means of a clip connection or screw connection or bayonet connection. The hollow body of any shape can comprise porcelain, glass and/or plastic. The base plate can be configured as a floor plate and serve as a stand or foot on which the hollow body rests. For this purpose, the base plate has a straight, flat floor surface. Alternatively, the base plate can be configured as a cover plate.

For example, as has already been explained above, the at least one illuminant can be arranged as a transmitter together with the control module in the housing of the device. In this case, the base plate of the housing can bear the processor, the at least one illuminant, and the inclination sensor and possibly an acceleration sensor (described further below). The lamp being well-sealed can thus also be used outdoors. In addition, the lamp is aesthetically more attractive due to the omission of an opening for a plug connection.

Alternatively, the housing can have an opening through which a plug connector can be passed if the lamp is to be charged by means of wired energy transmission.

In one exemplary embodiment, the at least one illuminant is integrated into a circuit board, which is arranged on the base plate and fastened there. Alternatively, the at least one illuminant (for example LEDs) can be arranged separately from the base plate above the base plate in a head part of the housing of the device. A body portion disposed beneath or adjacent to the translucent head portion of the housing can be configured to be optically dense in relation to the electromagnetic radiation used in the lamp. In this case, a lens or a plurality of lenses can be provided, which is/are placed in front of the at least one illuminant so that it lies in the path of the light emitted by the illuminant. By this means, a functional lamp such as a desk, reading or travel lamp can be implemented.

Similarly to the lamp, the playback device can have a housing inside which the at least one loudspeaker and optionally the control module with the processor and the inclination sensor and optionally an additional acceleration sensor are arranged. Similarly to the lamp, the display device can have a base which is attached to a head part of the housing and supports the other elements and assemblies arranged inside the housing.

In a further exemplary embodiment, the transmitter can comprise a combination of at least one illuminant and at least one loudspeaker, for example for use as a table loudspeaker. This exemplary embodiment of a device can also be configured in such a manner that the combined transmitter is arranged together with the control module in a common housing or is designed separately as two separate units.

In a separate design of the control module, this can be designed, for example, as a cuboid, cube, cylinder or another shape with a defined footprint, so that it is intuitively clear to the user which position constitutes the rest position of the control module. By this means it is also clear to the user in which direction a tilting of the control module must be accomplished so that the inclination sensor detects a tilting movement and, on this basis, as described above and below, brings about a control of the transmitter depending on the state adopted by the transmitter. The possible tilting direction(s) for operating the control module can also be made clearer by a special surface design of the control module, e.g., by a color and/or pattern design.

In one exemplary embodiment with such a combination, the “active/passive transition” presented above can be modified in such a manner that as a result of the relevant tilting movement described above, it is possible to “switch” between a first active state and several other active states and optionally a passive state, for example in a predetermined sequence, wherein during the transitions between the different active states the at least one loudspeaker of the playback device and the at least one illuminant can be controlled separately, so that a wide variety of loudspeaker/illuminant combinations can be realized. In the passive state, the transmitter, i.e., loudspeaker and illuminant, is switched off. This means that in the various active states the operating mode of the transmitter in relation to at least one setting variable (e.g., in terms of brightness, color temperature, volume) is different, which includes the fact that a part of the (possibly combined) transmitter is switched off (i.e., brightness or volume are zero). For example, in a device in which the transmitter comprises a combination of a loudspeaker and at least one illuminant, when a tilting movement from the rest position or from the tilted position is detected with a second change of inclination angle over a first tilting time interval, the transmitter can go over from a passive state into a first active state in which the loudspeaker and the at least one illuminant are switched on,
in the case of another such tilting movement with a first change of angle of inclination, the transmitter can go over from the first active state to a second active state in which the loudspeaker is switched on and the at least one illuminant is switched on with low brightness or, if there are a plurality of illuminants, some of these illuminants are switched on,
in the case of another such tilting movement, the transmitter can go over from the second active state into a third active state in which the at least one illuminant is switched on with low brightness or, if there are a plurality of illuminants, some of these illuminants are switched on and the loudspeaker is switched off,
in the case of another such tilting movement, the transmitter can go over from the third active state into a fourth active state, in which the at least one illuminant is switched off and the loudspeaker is switched on,
in the case of another such tilting movement, the transmitter can go over from the fourth active state into a fifth active state in which the at least one illuminant is switched on, its brightness is controlled as a function of the playback device sound pressure level and the loudspeaker is switched on, and
in the case of another such tilting movement with a second change in angle of inclination, the transmitter can go over into the passive state.

In this way, the various wishes of the users in relation to the configuration of such a combined device can be met. The third active state of the transmitter can be used, for example, to find the device at night. The second active state can serve for use in a pleasant ambient atmosphere, the fourth active state allows use only as a playback device while the lighting effect is not desired. In the fifth active state, the transmitter can be used at a party, for example. Other sequences of the states and states with other specific settings of the illuminants and the loudspeaker are also possible.

With regard to the processor, in one exemplary embodiment in particular, a state can be implemented in which the processor allows a connection device for wireless communication (Bluetooth pairing) and this state can be exited automatically as soon as such a connection has been successfully set up.

According to the invention, the processor of the control module can use the detected values of the change in inclination angle or the traversed inclination angle of the inclination sensor in a predetermined time interval to determine whether in the predetermined time interval the device executes a slow tilting movement or a rapid tilting movement, no movement or a movement differing from these two movements (e.g., a purely translational movement without tilting).

This measurement and evaluation is carried out continuously or at regular intervals (corresponds to the first tilting time interval, e.g., every 50 ms). By determining the angle of inclination/the change in the angle of inclination as specified above, the inclination sensor measures an inclination of the inclination sensor with respect to the vertical direction predetermined by gravity or a predetermined z-axis, which can run in the vertical direction, for example. Alternatively, it may be determined by the processor whether the device performs a slow tilting movement or a rapid tilting movement, no movement or a movement that differs from these two movements (e.g., a pure translational movement without tilting) by measuring the time in which the device goes through a predetermined change in inclination angle. This measurement and evaluation is repeated continuously or periodically via predetermined changes in angle (e.g., every 5°). The measurement variables specified above can then be related either to the rest position or to a tilted position of the inclination sensor.

The device according to the invention has the advantage that switches or buttons are not required for switching and dimming. With regard to touch dimming, there is the advantage that the device can be grasped and its position changed without a change in brightness, for example, taking place at this moment. The situation is similar with the device according to the invention when this is compared with conventional gesture control. In the case of gesture control, unwanted dimming or switching can occur when the hands approach, which is avoided with the device according to the invention.

Devices according to the invention such as lamps or playback devices, in particular for the table and/or for outdoor use, can be switched on and off and dimmed easily, error-free and safely without a visible switch, or their color or color temperature can be changed.

In relation to the present invention, the processor is an electronic circuit that controls the transmitter and possibly other elements of the device according to commands given and thereby executes and promotes an algorithm. For example, the processor is configured as a microcontroller or central processing unit (CPU) for signal evaluation and for controlling the transmitter. The transmitter can also have a driver stage that is used to control the transmitter. The driver stage can be provided with a plurality of channels, for example for a plurality of illuminants. The processor also has a clock unit/clock generator in order to determine time intervals.

The inclination sensor measures the inclination angle with respect to the vertical direction (for explanation of this see below) or its change. The inclination sensor can here correspond to a classical inclination sensor, a precision mechanical or electrical measuring device that measures the mechanical change deflection of solid, liquid and/or gaseous elements when inclined in relation to the vertical direction (i.e., in the direction of gravitational acceleration). Alternatively, the inclination sensor can be implemented by an acceleration sensor (also designated as an accelerometer, acceleration transducer, accelerometer) aligned in the direction of a rest position, which measures the acceleration in relation to a z-direction, wherein the z-direction substantially corresponds to the vertical direction and the device has a defined inclination with respect to the vertical direction in the rest position. In relation to the present invention, the additional acceleration sensor optionally provided in one exemplary embodiment is a sensor that measures an acceleration in all three directions of three-dimensional space or the change in acceleration, or at least in a direction that differs from the z-direction. The additional acceleration sensor and the inclination sensor can be integrated into a common sensor module, which in turn is part of the control module. The variables specified above can be recorded continuously or periodically after a specified time interval (e.g., every 50 ms). The inclination sensor and the additional acceleration sensor can each be configured as a semiconductor component. Alternatively or additionally, non-semiconductor sensors can be used which are based on a mechanical, electrical and/or magnetic operating principle. If a large acceleration is measured by an acceleration sensor, this corresponds to a large change in inclination angle whereas the measurement of a small acceleration in relation to the respective direction corresponds to a small change in inclination angle. Alternatively, as has already been explained above, the time intervals over which a predetermined change in the angle of inclination has occurred can be measured. This corresponds to a measurement of a change in the angle of inclination over a predetermined time interval and constitutes an embodiment of the invention.

The state of the transmitter in which the transmitter emits electromagnetic radiation and/or sound waves is designated as the active state. In order to emit electromagnetic radiation and/or sound waves, the transmitter is switched on in the active state. If the transmitter is switched on, the transmitter can be switched off by the processor and then goes over into the passive state. After switching off, i.e., in the passive state, the transmitter does not emit any electromagnetic radiation and/or sound waves. In the passive state, the device has a low power consumption which, however, is higher overall than the power consumption in the so-called sleep state of the processor, which is explained in detail below.

In addition, the transmitter can go over from the active state into a setting state in which, as already explained above, at least one setting variable of the transmitter can be changed by the processor in accordance with a predetermined manner of change. In the case of an illuminant, the setting variable can comprise an intensity and/or a frequency and/or color temperature and/or another setting variable. In the setting state, the intensity and/or the frequency and/or the color temperature and/or another setting variable of the electromagnetic radiation can be changed according to a predetermined manner of change. In the case of a loudspeaker, the setting variable can comprise a sound pressure level (volume) emitted by the at least one loudspeaker and/or a selection of a piece of music stored in a memory for playback and/or another setting variable. In the setting state, the sound pressure level and/or the selection of a piece of music stored in the memory for playback and/or another setting variable can be changed according to a predetermined manner of change. For example, a transition back into the active state from the setting state can take place if the inclination sensor is tilted back into its rest position. The change of the at least one setting variable can take place, for example, as long as the inclination sensor is slowly tilted and/or as long as it remains in the tilted position. As explained above, only the tilting back can result in the end of the setting/change of the at least one setting variable and in a return to the active state. In an exemplary embodiment, the speed or the extent of the change can be influenced by a larger or smaller inclination angle in the setting state. For example, the at least one setting variable can be changed substantially if slow tilting continues. A change by a small amount occurs when the inclination sensor remains at the inclination angle. Furthermore, a renewed (second) transition into the setting state (after a first slow tilting, returning into the rest position and renewed slow tilting) can result in a reversal of the direction of change of the manner of change of the at least one setting variable. For example, during the first transition into the setting state, a dimming of the at least one illuminant can take place at higher intensity and after returning into the active state and another transition into the setting state, a dimming of the at least one lamp can take place at lower intensity of the electromagnetic radiation. The processor of the device can store the last used direction of change of the last setting state in a corresponding storage device and with each new transition into the setting state, reverse the direction of change of the respective setting variable of the transmitter compared to the last used direction of change.

In one exemplary embodiment, the determination of the type of tilting movement defined above can be made from a tilted position. For example, the device and thus the inclination sensor can be inclined from the rest position into a tilted position, wherein the tilted position is identified, for example, by the inclination angle in relation to the rest position or the vertical direction exceeding a predetermined starting inclination angle. Exceeding the starting inclination angle can also be designated as initialization. As soon as the processor has detected the tilted position, the processor observes the change in inclination angle measured by the inclination sensor within a first tilting time interval (e.g., within an interval of 200 ms to 1.5 s, e.g., 800 ms). The first tilting time interval starts when the predetermined starting inclination angle is exceeded (i.e., adopting the tilted position). If in the first tilting time interval starting from the tilted position, a first change in angle of inclination, for example, a maximum change in angle of inclination over a first small magnitude of the angle of inclination (e.g., 5°), is determined (corresponds to a slow tilting movement), the transmitter goes into the setting state and a setting variable of the transmitter can be changed. For example, an illuminant can be dimmed in terms of brightness, as shown above. If, however, in this exemplary embodiment, a second change in inclination angle is determined in the first tilting time interval, for example, a large change in inclination angle, for example a change in inclination angle of at least 30° or a change in inclination angle that reaches at least a predetermined final inclination angle (corresponds to a rapid tilting movement), then the transmitter goes over from the active state (transmitter switched on) into the passive state (transmitter switched off). For example, the final inclination angle can differ from the rest position by only a second small magnitude of the inclination angle so that this tilting movement describes a rapid tilting movement from the tilted position into a position near and in the region of the rest position. In one exemplary embodiment, the magnitude of the first inclination angle is significantly smaller than the amount of the difference between the starting angle of inclination and the final angle of inclination. In addition, the starting angle of inclination is greater than the final angle of inclination, in each case relative to the z-axis (rest position).

It should be emphasized at this point that the behavior of the device specified above when performing the tilting movement in relation to the rest position or from a tilted position is based on determining whether the tilting movement takes place fast or slowly. In each case, the change in inclination angle is considered in relation to the same (first) tilting time interval. If the change in inclination angle is large, the device is being tilted rapidly, whereas if the change in inclination angle is small, the device is being tilted slowly. The above definition encompasses an exemplary embodiment in which the transition from the active into the passive state (and conversely) takes place with a rapid tilting movement (i.e., with a large change in inclination angle over the first tilting time interval) whereas the transition from the active state into a setting state takes place with a slow tilting movement (i.e., with a small change in inclination angle over the first tilting time interval). Conversely, the above definition also encompasses an exemplary embodiment in which the transition from the active into the passive state (and conversely) takes place with a slow tilting movement (i.e., with a small change in inclination angle over the first tilting time interval), whereas the transition from the active state into a setting state takes place with a rapid tilting movement (i.e., with a large change in inclination angle over the first tilting time interval). Here, the change in inclination angle is measured continuously in second tilting time intervals (e.g., every 50 ms to 1 s, for example 500 ms). If, for example, the angle of inclination in relation to the rest position exceeds a predetermined trigger angle of inclination, by reading out a memory with changes in angle of inclination according to the principle of a queue buffer memory (FIFO buffer), a decision is made as to whether the change in the inclination angle has taken place rapidly or slowly (large or small change in the angle of inclination) in the time interval before the trigger angle of inclination was exceeded. Correspondingly, after reading the queue buffer memory, either an “active/passive state transition”, a transition into another active state or a transition into a setting state is effected. If the starting inclination angle defined above is exceeded, the change in inclination angle starting from this tilted position can be observed by the processor, as described above, and it can be determined whether this takes place slowly (e.g., slow tilting or holding) or rapidly (e.g., rapid tilting back into the rest position).

In a further exemplary embodiment, the transition from the passive state into the active state of the transmitter can be directly followed by a predetermined change in a setting variable (e.g., dimming the brightness of the illuminant or changing the volume of the loudspeaker). Here, the initial value of the respective setting variable is specified for the transition into the active state (e.g., minimum brightness, lowest volume). The slow change of the setting variable can be stopped as soon as the device has reached a certain state, e.g., the rest position.

In one embodiment, the manner of changing (i.e., the type and manner of changing) the at least one setting variable in a respective setting state (e.g., by the manufacturer of the lamp or the user) are specified individually. For example, in a pure dimming mode of the lamp, only the intensity of the at least one illuminant, e.g., in 5 percent increments towards higher intensity and (in the opposite direction) towards lower intensity can be changed. In a pure color change mode, for example, the frequency and/or the color temperature can be changed, e.g., from a color temperature of 1,000 K up to a color temperature of 12,000 K. A mixed dimming/color changing mode can also comprise a combination of the two aforesaid modes. For example, the manner of change can include the following procedure: a pure dimming mode is implemented in the middle range of the intensity of the electromagnetic radiation, dimming with an additional change in the direction of a lower color temperature in a low-intensity range, and dimming with an additional change in color temperature towards high color temperature in a high-intensity range.

In order to enable a setting of different setting variables of the electromagnetic radiation and/or the sound waves in a simple and intuitive manner, in one exemplary embodiment the active state can have at least a first mode and a second mode (e.g., a dimming mode and a color changing mode). Correspondingly, the setting state can have at least one first mode (e.g., setting state for dimming for the dimming mode) and a second mode (e.g., setting state to change the color for the color change mode), wherein
the processor, when ascertaining a tilting movement of the inclination sensor from the rest position or from the tilted position with a first change in inclination angle over a first tilting time interval, controls the transmitter in such a manner that it goes over from the first mode of the active state to the first setting state mode, in which at least one first setting variable can be changed in accordance with a first predetermined manner of change, and
the processor when ascertaining a tilting movement of the inclination sensor from the rest position or from the tilted position with a first change in inclination angle over a first tilting time interval controls the transmitter in such a manner that it goes over from the second mode of the active state into the second setting state mode, in which at least one second setting variable can be changed according to a second predetermined manner of change, wherein the at least one second setting variable differs from the at least one first setting variable and/or the second predetermined manner of change of the at least one second setting variable differs from the first predetermined manner of change of the at least one first setting variable, and/or
the processor when ascertaining a double tilting movement of the inclination sensor in quick succession from the rest position or the tilted position, controls the transmitter in such a manner that it goes over from the first mode of the active state into the second mode of the active state or conversely, depending on which mode was adopted by the transmitter before the double tilting movement, or
when ascertaining a tilting movement of the inclination sensor from the rest position or from the tilted position with a third change of inclination angle over the first tilting time interval, the processor controls the transmitter in such a manner that it goes over from the first mode of the active state into the second mode of the active state or conversely, depending on which mode was adopted by the transmitter prior to this tilting movement, wherein the third change in inclination angle differs from the first change in inclination angle and the second change in inclination angle.

The provision of different modes in the active state and relevant setting states allows the user to make different settings of the device or the transmitter very easily, without a button or the like having to be provided for this purpose. The control (operation) is quite intuitive in this case and corresponds to the control described above for the transition from the active state into the setting state or into the further active state, for the control in the setting state or for the return into the active state, specifically for the at least one first mode and the second mode separately. As a result of the aforementioned double rapid tilting movement, it is possible to change to and fro between the first mode of the active state and the second mode of the active state. Alternatively, it is possible to change to and fro between the active modes by a particularly slow tilting movement (for example, from the tilted position, i.e., the third change in angle of inclination is small) or a particularly rapid tilting movement (likewise, for example from the tilted position). It is similarly possible to represent more than two modes of the active state and corresponding setting state modes. In one exemplary embodiment, the possibility can be provided, e.g., if the first setting state mode is the more frequently used setting state, that the transmitter automatically switches into the first mode of the active state after a predetermined time interval has elapsed in the second mode of the active state without transition into the second setting state mode. This appreciably facilitates operation by the user. The predetermined time interval for this can be 30 seconds or several minutes, for example.

For the same reason, acceptance of the new control concept is also made easier if, in one exemplary embodiment, the first mode of the active state is initially adopted after transition of the transmitter from the passive state into the active state.

As has already been described above, in the setting state the processor changes the at least one setting variable in accordance with the predetermined manner of change until it detects a tilting movement back into the rest position. This also applies correspondingly to the first setting state mode and the second setting state mode.

According to one exemplary embodiment of the device, a sleep state of the processor should be distinguished from the active state and the passive state of the transmitter. In the sleep state of the processor, the device only consumes extremely little power. The transmitter can neither be switched on nor off in the sleep state of the processor and it is not possible to go over into the setting state. The sleep state is used, in particular, to save energy during transport or storage of the device, which energy is stored in a rechargeable storage element (rechargeable battery), for example. The sleep state of the processor is designed in such a manner that in this state only the transition into the active state of the processor can take place. Only a small part of the electrical circuit of the device is energized in the sleep state, so that the control module can only be sent a wake-up signal when the device is to leave the sleep state of the processor and the processor is to go over into the active state, wherein the processor in the active state operates according to its predetermined operating mode, is energized and controls the device and in particular the transmitter, and specifically in all the states of the transmitter described above.

It is advantageous if the device has a rechargeable storage element (rechargeable battery) for supplying the device with electrical energy, which can be charged by a charging unit using wireless energy transmission via inductive or capacitive coupling. Alternatively or additionally, the rechargeable storage element can be charged by means of wired energy transmission via an electrical coupling. The device is also designated as a battery-operated device. For the inductive coupling, the device has a corresponding induction coil, which is connected to the storage element. A corresponding electronic circuit is also provided for charging. A storage element (and optionally the induction coil and the electronic circuit for charging) can be provided in a multi-part device both in the at least one transmitter unit and also in the control module. The storage element, the induction coil and/or the electronic circuit can be arranged on a base plate, wherein the base plate, as explained below, can serve as a floor or top plate. If the base plate is designed as a floor plate, the device with the floor plate is placed on the charging unit. If the base plate forms a top plate, the device must be turned over before charging and placed with this top plate, quasi upside down, on the charging unit. The charging unit can be configured as a charging plate or charging pad, for example. As a result, no connectors or cable connections are required on the outside of the device which could impair the aesthetic effect of the device. In the case of wired charging of the storage element, a connection for plugging in the charging cable can be provided, e.g., on the base plate. The device can also be configured to be movable and is not dependent on placement near a power supply. A battery-operated device is usually designed in such a manner that it can adopt the sleep state described above, in which only a very small amount of power is consumed in order not to unnecessarily discharge the storage element. In one exemplary embodiment, the inclination sensor and possibly the acceleration sensor in the sleep state of the processor are without supply voltage and thus without current but are supplied with voltage in the active state of the processor.

Alternatively, the device can also be designed as a device that is operated at mains voltage with and without the use of power supply units. With regard to their electronic circuitry, such devices are designed in such a manner that they have a low, tolerable power consumption, in particular when the transmitter is not being operated (so-called standby mode).

In one exemplary embodiment, the device has the sleep state in which the consumption of electrical energy in the device is limited to a minimum value, wherein the processor is adapted in such a manner that it goes over from a sleep state into the active state of the processor (so-called wake-up) when a coupling of the device to the charging unit is detected, for example, over a predetermined time interval, which lies between 1 and 5 seconds. In one exemplary embodiment, the transmitter can be switched off automatically during the transition into the sleep state so that electromagnetic radiation or sound waves are no longer emitted. Correspondingly, the transmitter can be switched on in the event of a transition into the active state of the processor. As a result, a user receives feedback that the sleep state or the active state of the processor has now been adopted.

It is also helpful for transporting the device if the device can be transferred into the sleep state again. For this purpose, the processor is adapted, for example, in such a manner that a transition from the active state into the sleep state is effected if the inclination sensor detects a shaking movement within a predetermined time interval. The shaking movement can be predominantly vertical (in the direction of the vertical) or predominantly perpendicular thereto (transverse) and is characterized by a multiple rapid to and fro movement (without significant tilting). The shaking movement can be detected by means of an inclination sensor and/or by means of an acceleration sensor. Alternatively, the processor can be transferred into the sleep state if the processor determines a tilting movement of the inclination sensor from the rest position or from the tilted position with a fourth change of inclination angle over a second tilting time interval, wherein the fourth change of inclination angle is greater than the first change of inclination angle and then the second change of inclination angle, for example, a change of inclination angle greater than 150° in relation to the rest position is detected. This means that the control module can be turned over (turned upside down) together with the lamp or playback device.

For mains powered devices, a sleep state is not required. Therefore, the evaluation of an interrupt (see below) can be omitted.

With regard to the above features of devices according to the invention, the angle of the axis of the inclination sensor to the axis position in the rest position of the inclination sensor is considered to be the angle of inclination. When the device is placed on a flat, level surface, the axis position in the rest position can be the vertical (parallel to the vertical direction).

With reference to the present invention, the rest position of the inclination sensor includes either an unchangeable, fixed, predefined course of the axis of the inclination sensor (e.g., along the vertical) or the rest position of the inclination sensor, i.e., the current tilt angle or course of the axis of the inclination sensor is tracked. This means that in the last-mentioned case, the rest position is always the position of the inclination sensor or its axis, which is adopted over a fairly long-time interval. A short-term change of position (e.g., by slow or fast tilting) is not or only minimally considered here. The tracking of the resting position can be achieved by tracking the inclination angle of the inclination sensor by the processor, for example by means of a PT1 element having a comparatively large time constant T(rest) (e.g., T (rest)>10 seconds).

According to one exemplary embodiment, the slow tilting of the inclination sensor in the active state of the transmitter can be determined whereby a change of inclination angle within a predetermined first time interval lies in a predetermined first range, for example in a range between 10° and 45°. The change can relate to the current rest position or an angle of inclination of the inclination sensor present at the beginning of the time interval of the measurement or the tilted position. In the implementation, the determination of the slow tilting can be accomplished with a PT1 element having a corresponding time constant T(LK)<T(rest).

According to one exemplary embodiment, the rapid tilting of the inclination sensor in the active state of the transmitter can be determined whereby a change in inclination angle lies within a predetermined second time interval in a predetermined second range, for example in a range between 100 and 45°, preferably between 10° and 30°. Here, the delimitation of the rapid tilting with respect to the slow tilting is accomplished over the respectively predetermined time interval. For rapid tilting, the second time interval can lie below a time interval limiting value, whilst for slow tilting the first time interval can lie above the time interval limiting value and optionally include this. In this case, the time interval limiting value is, for example, in the range between 100 ms and 800 ms, preferably in the range between 300 ms and 600 ms. For example, if the time interval limiting value is 500 ms, then a fast tilt is detected when the change in angle between 100 and 450 takes place over a time interval (period) that is less than 500 ms, e.g., 400 ms. On the other hand, a slow tilt is detected when a change in angle in the range of 100 to 450 takes place over a time interval (period) equal to or greater than 500 ms, e.g., 600 ms. Alternatively, the time intervals for each form of tilting can be specified separately. In addition, it is advantageous if the first time interval and the second time interval or the time interval limiting value is specified or set individually, depending on the respective device. When specifying/setting the time intervals or the time interval limiting value, the weight of the device or the control module, its shape and the weight distribution of the device/the control module along its vertical and/or horizontal extension are taken into account, for example, since a light device/a light control module can be tilted more rapidly than a heavy device/a heavy control module, etc. These parameters can be specified/set by the manufacturer and/or by the user. As has already been explained above, this procedure is equivalent to a different change in inclination angle in the case of rapid/slow tilting over the same time interval, since in both cases it is measured whether the tilting takes place rapidly or slowly.

The change in the angle of inclination can relate to the current rest position or to an angle of inclination of the inclination sensor (tilted position) at the beginning of the time interval of the measurement. In the implementation, the slow tilting can be determined with a PT1 element having a corresponding time constant T(SK)<T(LK). According to the invention, the rapid tilting causes the transition from the active state into the passive state or from the passive state into the active state or, if the active state has several modes, the first mode of the active state or the second mode of the active state.

A double rapid tilting for the detection of the double tilting can be determined, for example, whereby a double rapid change of inclination angle according to the above explanations for the (single) rapid tilting and a return taking place between the first tilting and the second tilting approximately into the rest position (e.g., angle of inclination deviates by 10° from the angle of inclination in the rest position) is detected. The change can relate to the current rest position or to an angle of inclination of the inclination sensor present at the beginning of the time interval of the measurement. This results in a transition from the first mode of the active state into the second mode of the active state or conversely.

In one exemplary embodiment, an acceleration sensor can also be provided in the control module, which is electrically connected to the processor and movable with the inclination sensor, wherein the processor is adapted in such a manner that it evaluates an acceleration and/or change in acceleration detected by the acceleration sensor continuously or periodically after each elapsing of at least one time interval and additionally uses it to control the transmitter, wherein the additional acceleration sensor, for example, evaluates the acceleration and/or change in acceleration in a direction that differs from a direction of the rest position, wherein the direction of the rest position, for example, is a direction which is substantially vertical in the rest position of the inclination sensor.

The acceleration sensor is used, for example, to determine the shaking movement, for example also in combination with the inclination sensor. Alternatively, only the inclination sensor can be used to detect the shaking movement. The shaking movement triggers transition into the sleep mode the processor. The additional acceleration sensor can also, if its observation direction differs from the axis occupied by the inclination sensor in the rest position, be used to detect a further direction of the tilting movement. Different tilting movement directions can be distinguished in relation to the axis of the rest position, since the acceleration sensor detects the acceleration in relation to its direction.

The sensor signals of the acceleration sensor and the inclination sensor are preferably present in the processor as digital information, which, for example, can be obtained via an I2C or SPI interface. The processor reads the information supplied by the sensors and uses this by means of its integrated software. For this purpose, the software can filter the signals and, in one exemplary embodiment, carries out a plausibility check before it concludes/determines a change in state therefrom. In one exemplary embodiment, the sensors can have a 3D movement and inclination measurement, but it is also possible to use sensors that have fewer sensor signals, e.g., 2D.

In one exemplary embodiment, the processor has no power in the sleep state in order to keep the energy consumption as low as possible in this state. In order to ensure that the electronics have as little power consumption as possible in the sleep state, the sensors are programmed in such a manner that they set a direct switching output if there is a significant signal (for example, a movement that exceeds a certain level). This switching output has the effect that the processor is informed about the detection of movement, preferably via an interrupt input. The processor, which was previously in the de-energized state, is reactivated by the set interrupt input and then immediately reads out all the sensor signals from the sensors. After a plausibility check, the interpretation of the sensor values now provided in detail results in the processor being switched on, which is then in the active state (possibly in the first mode of the active state). In this state, the processor periodically reads out the sensor signals cyclically, e.g., every 10 ms or every 50 ms, and evaluates them.

Alternatively to the interrupt signal of the acceleration sensor and the inclination sensor, a signal from an additional vibration sensor or position sensor separate from the acceleration sensor or the inclination sensor can also be used to bring about the transition of the processor into the active, switched-on state. F or this purpose, the vibration sensor or the position sensor either uses the interrupt input of the processor or ensures that the power supply for the entire electronics is switched on. Vibration sensors and position sensors are frequently constructed as mechanical sensors and do not require a power supply. If the sensor switches, the power supply unit of the electronics is reactivated. This circuit technology requires a power supply circuit that can be activated by the vibration or position sensor and can be switched off again by the processor.

Alternatively, the inclination and/or acceleration sensor can be realized by a mechanical structure, e.g., by a pendulum, which operates simply constructed switching elements or by a magnetized ball, which activates magnetic field-sensitive components (e.g., reed switch, Hall elements). This also results in an extremely low power consumption in the active, switched-off state and in the sleep state.

With regard to a device that has a transmitter for emitting sound waves, the processor can use the acceleration values detected by the acceleration sensor and the inclination angles detected by the inclination sensor in relation to a movement of the inclination sensor after evaluation to control the transmitter in an active state in such a manner that the transmitter upon determining a rapid double tilting movement of the inclination sensor from the rest position by the processor effects a selection of a piece of music for playback by switching a piece of music to the next piece of music, wherein the double tilting movement must be accomplished within a predetermined time interval.

In particular, the invention also comprises a method for controlling a device described above with the following steps:
continuous or periodical, after each elapsing of at least one time interval, recording of an inclination angle and/or a change in inclination angle in relation to a movement of the inclination sensor by the inclination sensor,
evaluation of the recorded inclination angle and/or the recorded change in inclination angle and use of the evaluated data to control the transmitter in an active state, in which the transmitter is switched on, or in a passive state, in which the transmitter is switched off, in such a manner

that the processor, when ascertaining a tilting movement of the inclination sensor from a rest position or from a tilted position in relation to a rest position with a first change of inclination angle over a first tilting time interval controls the transmitter in such a manner that it goes over from an active state into a setting state, wherein in the setting state at least one setting variable of the transmitter can be changed by the processor according to a predetermined manner of change or goes over into a further active state, wherein in the further active state the operating mode of the transmitter in relation to at least one setting variable is changed compared to the active state, and

that the processor when ascertaining a tilting movement of the inclination sensor from the rest position or from the tilted position with a second change in inclination angle over the first tilting time interval controls the transmitter in such a manner that it goes over from the active state or the further active state into the passive state or goes over from the passive state into the active state, wherein the second change in inclination angle differs from the first change in inclination angle.

In one exemplary embodiment, the active state has at least a first mode and a second mode, and the setting state has at least a first mode and a second mode, wherein
the processor, when ascertaining a tilting movement of the inclination sensor from the rest position or from the tilted position with a first change in inclination angle over a first tilting time interval, controls the transmitter in such a manner that it goes over from the first mode of the active state to the first setting state mode, in which at least one first setting variable can be changed in accordance with a first predetermined manner of change, and
the processor, when ascertaining a tilting movement of the inclination sensor from the rest position or from the tilted position with a first change in inclination angle over a first tilting time interval controls the transmitter in such a manner that it goes over from the second mode of the active state into the second setting state mode, in which at least one second setting variable can be changed according to a second predetermined manner of change, wherein the at least one second setting variable differs from the at least one first setting variable and/or the second predetermined manner of change of the at least one second setting variable differs from the first predetermined manner of change of the at least one first setting variable, and/or
wherein the processor, when ascertaining a double tilting movement of the inclination sensor in quick succession from the rest position or the tilted position, controls the transmitter in such a manner that it goes over from the first mode of the active state into the second mode of the active state or conversely, depending on which mode was adopted by the transmitter before the double tilting movement, or
when ascertaining a tilting movement of the inclination sensor from the rest position or from the tilted position with a third change of inclination angle over the first tilting time interval, the processor controls the transmitter in such a manner that it goes over from the first mode of the active state into the second mode of the active state or conversely, depending on which mode was adopted by the transmitter prior to this tilting movement, wherein the third change in inclination angle differs from the first change in inclination angle and the second change in inclination angle.

In one exemplary embodiment, the above-described control/operation of a transmitter by means of a tilting movement can also be combined with touch operation, with operation using an electrical or mechanical switch or button and/or with non-contact gesture control (e.g., via a camera, a proximity sensor and/or an E-field sensor) of this transmitter.

The operating mode of the method according to the invention and its advantages have already been described in detail above in connection with the device. Reference is made to this and to the other exemplary embodiments presented there.

The invention is explained hereinafter with reference to exemplary embodiments and with reference to the figures. All of the features described and/or illustrated form the subject matter of the invention, either alone or in any combination, even independently of their summary in the claims or their back-references.

### BRIEF DESCRIPTION OF THE DRAWINGS

In the figures shown schematically

FIG. 1a shows a first exemplary embodiment of a device according to the invention in the form of a lamp in a perspective view from the side and in a passive state of the transmitter,

FIG. 1b shows a second exemplary embodiment of a device according to the invention with a lamp as a transmitter unit and a separate control module in a perspective view from the side in a passive state of the transmitter,

FIG. 2 shows a rapid tilting of the exemplary embodiment according to FIG. 1a,

FIG. 3 shows the embodiment according to FIG. 1a in an active state in a perspective view from the side,

FIG. 4 shows the rapid tilting of the exemplary embodiment according to FIG. 1a,

FIG. 5 shows the exemplary embodiment according to FIG. 1a in a passive state in a perspective view from the side,

FIG. 6 shows the embodiment according to FIG. 1a in an active state in a perspective view from the side,

FIG. 7 shows a slow tilting of the exemplary embodiment according to FIG. 1a,

FIG. 8 shows the exemplary embodiment according to FIG. 1a in an active state after dimming in a perspective view from the side,

FIGS. 9-11 show a second to fourth embodiment of a device according to the invention in the form of a lamp, in each case in a perspective view from the side and in an active state of the transmitter,

FIG. 12a shows a shaking of the exemplary embodiment according to FIG. 1a in an active, switched-on state in a view from the side and reaching the sleep state of the processor,

FIG. 12b shows a second variant of the shaking of the exemplary embodiment according to FIG. 1a in an active state in a view from the side and reaching the sleep state of the processor,

FIG. 13a shows the exemplary embodiment according to FIG. 1a in a sleep state in a view from the side, its activation to reach the active state of the processor and rapid tilting to reach the active state of the transmitter,

FIG. 13b shows a variant of the exemplary embodiment according to FIG. 1a in a sleep state in a view from the side, its activation to reach the active state of the processor and rapid tilting to reach the active state of the transmitter,

FIG. 14 shows a fifth exemplary embodiment of a device according to the invention in the form of a lamp in a view from the side in a sleep state,

FIG. 15 shows the exemplary embodiment according to FIG. 14 in a longitudinal section,

FIG. 16 shows a sixth exemplary embodiment of a device according to the invention in the form of a lamp in a perspective view from below in a sleep state,

FIG. 17 shows the exemplary embodiment according to FIG. 16 in a view from the side in a sleep state,

FIGS. 18-23 show components of the exemplary embodiment according to FIG. 16, each in a perspective view from the side,

FIG. 24 shows a seventh exemplary embodiment of a device according to the invention in the form of a playback device in a perspective view from the side in a sleep state,

FIG. 25 shows the exemplary embodiment according to FIG. 24 in a view from the side in a sleep state,

FIG. 26 shows the embodiment according to FIG. 24 in a longitudinal section,

FIG. 27 shows a block diagram of the exemplary embodiment shown in FIG. 1a,

FIG. 28 shows a diagram for a first exemplary embodiment of a control method,

FIG. 29 shows a scheme for a second exemplary embodiment of a control method,

FIG. 30 shows an eighth exemplary embodiment of a device according to the invention in a perspective view from the side,

FIG. 31 shows the exemplary embodiment according to FIG. 30 in a view from the side,

FIG. 32 shows the exemplary embodiment according to FIG. 30 in a longitudinal section along the line A-A (see FIG. 31),

FIG. 33 shows a ninth exemplary embodiment of a device according to the invention in a perspective view from the side,

FIG. 34 shows the exemplary embodiment according to FIG. 33 in a side view, and

FIG. 35 shows the embodiment according to FIG. 33 in a longitudinal section along the line B-B (see FIG. 34).

### DETAILED DESCRIPTION OF THE PREFERRED EMBODIMENTS

The following description of exemplary embodiments takes place, in particular, with regard to devices which have a transmitter for emitting electromagnetic radiation (in the visible wavelength range—i.e., light). The description can be applied similarly to exemplary embodiments with a transmitter that emits sound waves (in the audible wavelength range) or combinations of such transmitters.

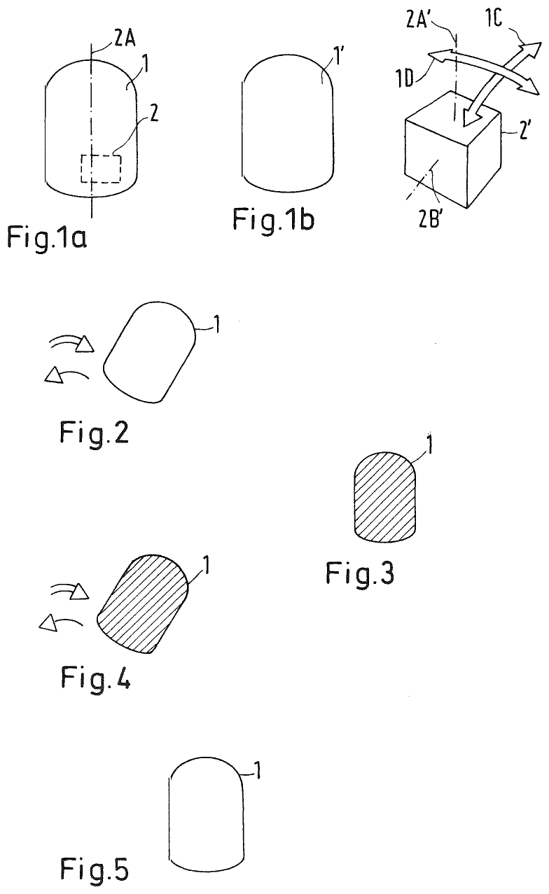

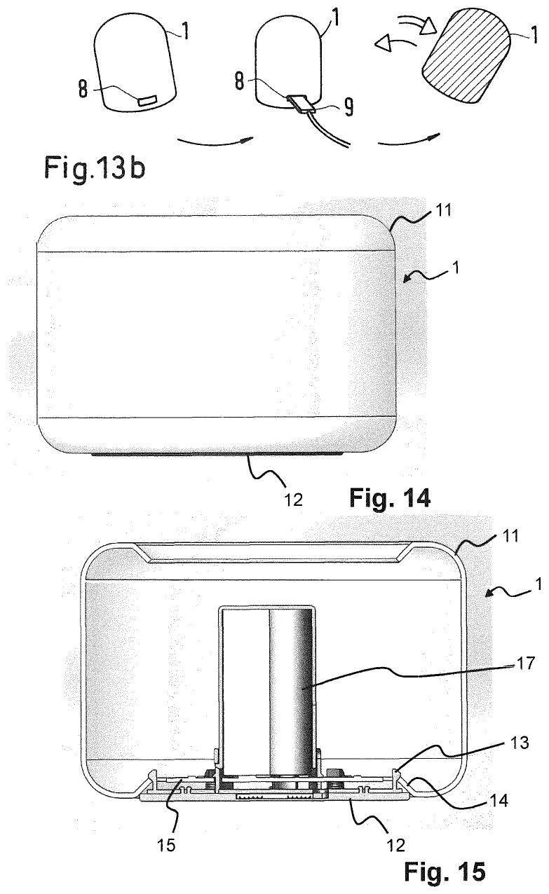

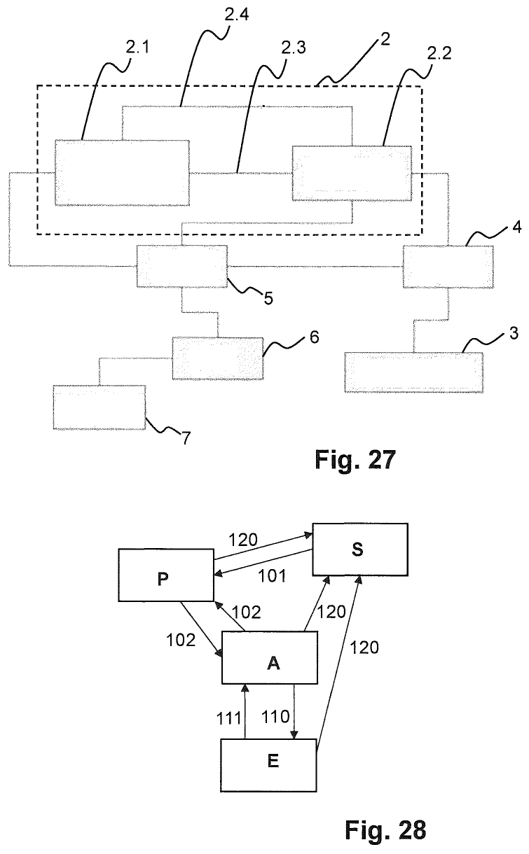

FIG. 1a shows a device according to the invention in the form of a lamp 1 in a rest position in which the lamp 1 is standing on a base, wherein the base, e.g., a table top, is indicated by hatching. A block diagram of the electronic elements of the lamp 1 is shown in FIG. 27. The lamp 1 has an integrated control module 2 which is arranged inside the lamp 1. In addition, the lamp 1 has a plurality of illuminants 3 which, in the sense of the invention, represent a transmitter for emitting electromagnetic radiation in the visible wavelength range. The illuminants 3 can be configured in the form of LEDs, for example. The illuminants 3 are also arranged inside the lamp 1 and connected to the control module 2 connected via a driver stage 4. The lamp 1 also has a power supply unit 5 and a rechargeable storage element (rechargeable battery 6), wherein the rechargeable battery 6 is connected to the control module 2 via the power supply unit 5. There is also an electrical connection between the rechargeable battery 6 and a charging circuit 7, which comprises a first charging coil and is adapted to charge the rechargeable battery 6 via an inductive coupling in a known manner with an external second charging coil. The second charging coil can be contained in a so-called charging pad 20 (see FIG. 13). The control module 2 also has a processor 2.2 and a sensor module 2.1 with an inclination sensor. The sensor module 2.1 can additionally or alternatively have one or more acceleration sensors. The sensor module 2.1 is connected to the processor 2.2 via a data line 2.3 for direct transmission of the angles of inclination detected by the sensor module 2.1 (and possibly acceleration values) to the processor 2.2. In addition, sensor module 2.1 and processor 2.2 are connected via an interrupt 2.4.

FIG. 1b shows a further exemplary embodiment of a device according to the invention with a lamp 1′ as a transmission unit and a separate control module 2′ with a processor and sensor module, which is constructed and operates similarly to the diagram in FIG. 27. In this exemplary embodiment, the lamp 1′ also has a first communication unit and the control module 2′ has a second communication unit, wherein the processor of the control module 2′ sends control signals for controlling the illuminant of the lamp 1′ to the lamp 1′ by means of the second communication unit and these are received by means of the first communication unit of the lamp 1′ (e.g., the communication channel Bluetooth is used). For this purpose, the first communication unit is connected to the illuminant of the lamp 1′ and the second communication unit is connected to the processor of the control module 2′.

FIGS. 9 to 11 show further lamps 1 by way of example, each having the same structure as the lamp 1 according to the first exemplary embodiment. All of them are distinguished by the fact that they have a closed housing, in particular one that is sealed against moisture and other environmental influences. The lamp 1 shown in FIG. 9 has the shape of a segment of a sphere. The lamp 1 shown in FIG. 10 has a cylindrical shape, while the lamp 1 sketched in FIG. 11 is also designed to be approximately cylindrical, but has a concavely curved lateral surface. All three lamps 1 of FIGS. 9 to 11 are shown in an active state (i.e., in a switched-on state). This is symbolized by the hatching pattern.

FIGS. 14 and 15 show a further embodiment of a lamp 1 whose housing comprises an approximately cylindrical hollow body 11 and a base plate 12. The translucent hollow body, which comprises a plastic, for example, is trans-illuminated by LEDs arranged inside the hollow body as illuminants. The control module with inclination sensor (and possibly acceleration sensor) and as well as processor, furthermore the illuminants, a driver stage, a power supply unit, a rechargeable battery 6 and a charging circuit are arranged above the base plate 12 on a circuit board 15. The base plate 12 is configured to be flat on the underside so that it can serve as a base for the lamp 1. On the side of the base plate 12, on the side opposite the underside, finger-shaped projections 13 protrude upwards into the cavity of the hollow body 11 which is arranged on the base plate 12. At its upper end remote from the base plate, each finger-shaped projection 13 has a snap-hook-like head which, when the hollow body 11 is arranged on the base plate, engages behind an inwardly high-domed edge 14 of the hollow body 11 in the manner of a snap or clip connection to fix the hollow body 11 to the base plate 12 and at the same time seal the interior of the housing.

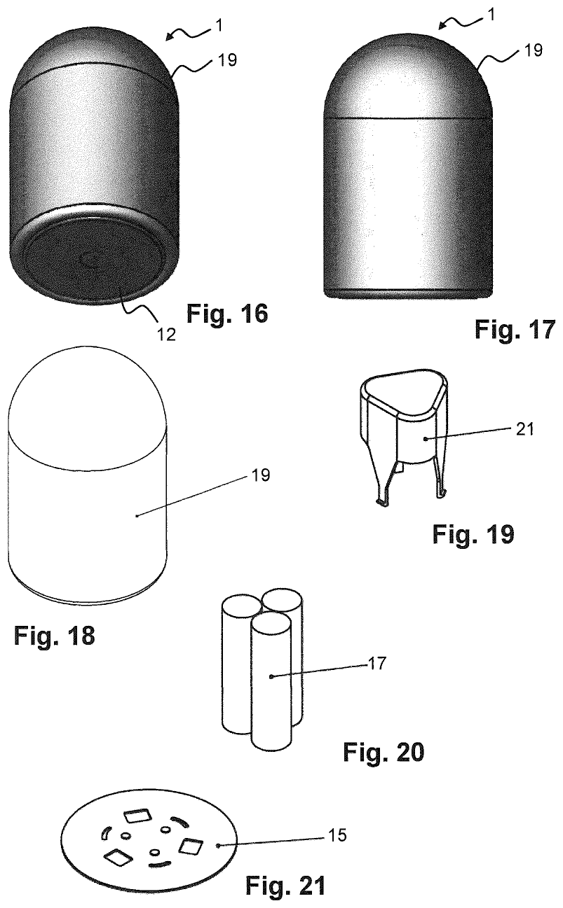

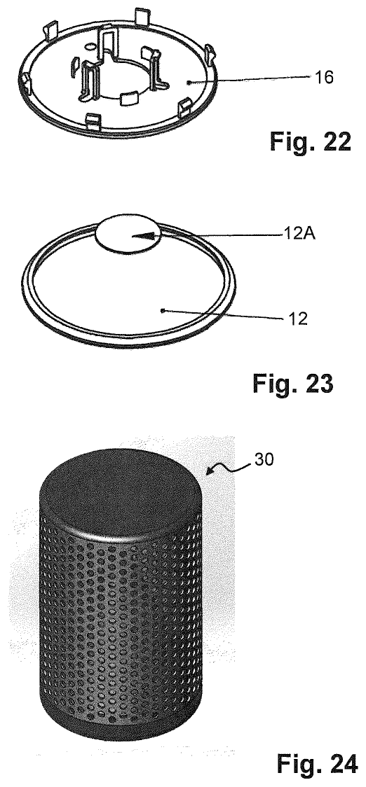

A further embodiment of a lamp 1 will now be described with reference to FIGS. 16 to 23. The lamp 1 provided with a hemispherical cap on the top side has a base plate 12 made of Santoprene on the underside. Together with a cover 19 made of translucent glass, which forms the hemispherical cap, the base plate 12 tightly seals the interior of the lamp 1. A plastic base plate 16 is provided above the bottom plate 12 which supports the remaining internal elements of the lamp.

An induction coil 12A arranged on the base plate 12 extends through a central opening in the plastic base plate 16. A circuit board 15 is also provided, on which the illuminants (e.g., a plurality of LEDs) and the charge and control electronics are arranged with the processor and sensor module. Further three rechargeable batteries 7 are held with a battery holder 21 on the circuit board. The battery holder 21 covers the three rechargeable batteries 7 from above, protrudes through corresponding through-openings in the circuit board 15 and is held by the plastic base plate 16 by means of a clip connection.

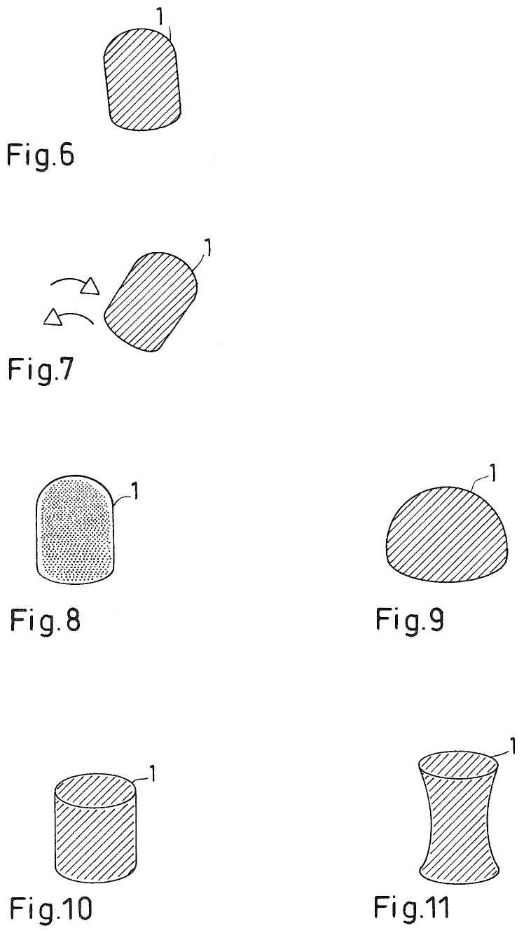

The operating mode and control of the lamp 1 is described below with reference to FIGS. 1a to 8, 12a to 13b and 28 and 29.

In FIG. 1a, the lamp 1 is initially in the passive (non-luminous) state resting on a flat surface. This state is denoted by P in FIG. 28. With a rapid tilting movement of the body to the side (see FIG. 2, double arrow and FIG. 28, left-hand arrow 102), no matter which side, the transmitter of the lamp is switched on and the illuminants light up. The transmitter is in the active state (A in FIG. 28). This is illustrated by the hatched pattern in the lamp in FIG. 3. In FIG. 3, the lamp 1 is again resting on the base described above. By rapidly tilting lamp 1 again (see FIG. 4 and right-hand arrow 102 in FIG. 28), the lamp 1 is switched off again (FIG. 5) and the transmitter enters the passive state P. During the tilting movement 2.1 the sensors of the sensor module detect the change in the angle of inclination in relation to a z-axis (see axis 2A in FIG. 1a) which, for example, approximately corresponds to the axis in the vertical direction, for example, in a first time interval that is less than 500 ms and in a second time interval that is greater than 500 ms. In this case, the inclination sensor has determined a large change in inclination in a time interval of less than 500 ms. As a result, the rapid tilting is recognized by the processor 2.2 and the transmitter of the lamp 1 is initially switched on (in the step shown in FIG. 2 and left-hand arrow 102 in FIG. 28) and then switched off again (in the step and shown in FIG. 4 and right-hand arrow 102 in FIG. 28).

If the lamp 1 is to be dimmed in the active state A, then the lamp 1 is slowly tilted, as shown in FIG. 7 by the single arrows. This was determined by the processor 2.2 since the change in the inclination angle took place in a predetermined range between 10° and 45° over a time interval which is longer than 500 ms (for example, is 600 ms). As a result, the transmitter of the lamp enters into the setting state E (see arrow 110 in FIG. 28). As long as the device is further slowly tilted or held, the control module 2 changes the intensity of the light emitted by the illuminant 3. For example, the intensity is dimmed downwards (i.e., the light intensity is reduced—the lamp 1 becomes dimmer), which is illustrated by the changed pattern in lamp 1 in FIG. 8. The setting state E for dimming is completed by returning to the rest position with the lamp upright (arrow 111 in FIG. 28). With another slow tilting movement 110, the transmitter of the lamp can re-enter the setting state E for dimming and can be dimmed upwards (i.e., the light intensity is increased—lamp 1 becomes brighter) and then, if there has been a brief switch to the rest position in between, with a next slow tilting movement, the lamp is dimmed downwards again and so on.

In order to place as little load as possible on the rechargeable battery 6 and to save energy, the lamp 1 is delivered in a sleep state of the processor (S see FIG. 28), which is shown in FIG. 13a (left-hand lamp 1). In addition, the lamp 1 cannot be accidentally switched on when the processor is in sleep state. In the sleep state S, the power consumption is very low, only the charging circuit 7 is active. The processor 2.2 and the sensor module 2.1 are de-energized. To activate the lamp 1, this is brought into the vicinity of the charging pad 20 (middle of FIG. 13a) so that the charging circuit 7 identifies the inductive coupling of the first charging coil of the lamp and the second charging coil of the charging pad 20 over a predetermined time interval (e.g., 2 seconds). As a result, the processor 2.2 and the sensor module 2.1 are switched on. The processor 2.2 with the sensor module is then in the active state and the transmitter is in the passive state P (see arrow 101 in FIG. 28). As already explained above with reference to FIGS. 1a to 3, the transmitter of the lamp 1 can then be switched on by means of a rapid tilting movement (left-hand arrow 102) and is then located in the active state, as is sketched on the right-hand side of the charging pad 20 shown in FIG. 13a. From the active state A of the transmitter, the lamp 1 can be switched off (arrow 102, direction P) and dimmed (arrow 110, direction E). This has already been described above. The charging circuit 7 is also provided for charging the rechargeable battery 6 in a known manner by means of the charging pad 20 via inductive coupling.

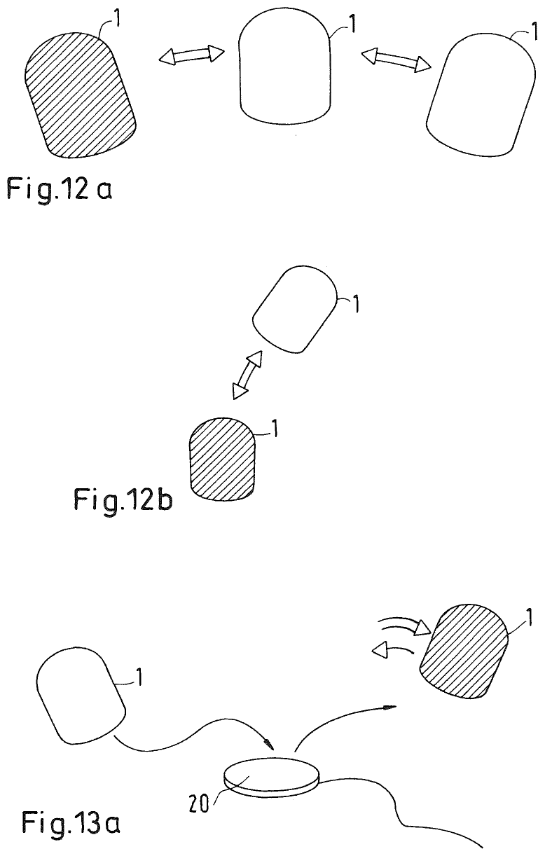

Finally, with reference to FIG. 12, it is described how the lamp 1 returns to the sleep state S of the processor. For shipping, transporting or storing the lamp 1, it is necessary to transfer the lamp 1 back into the sleep state S to avoid a deep discharge of the rechargeable battery. This is accomplished, for example, from the active state A of the transmitter of the lamp 1 (see illustration on the left in FIG. 12a) with a brief, vigorous shaking of the lamp, which is illustrated by the double arrows in FIG. 12a. The transition into the sleep state S of the processor is shown by the arrow 120 in the diagram of FIG. 28. As a result of the transition into the sleep state S, for example, the processor 2.2 and the sensor module 2.1 are switched off, so that the illuminant 3 is switched off. This is shown in the central and right-hand image of the lamp 1 in FIG. 12. By this means the user can also detect that the processor has been transferred into the sleep state. The lamp 1 can be easily shipped or stored in the sleep state. This sleep state S is only left again, as described above, and the lamp 1 is transferred into the passive state P (see arrow 101 in FIG. 28) with another brief charge on the charging pad 20.

FIG. 12a shows shaking in the horizontal direction, wherein the lamp 1 only has a small angle of inclination. Alternatively, the shaking can also take place in the vertical direction, as shown in FIG. 12b.

The transition into the sleep state S can also take place from the passive state P or from the setting state E of the transmitter by shaking described above. This is shown in FIG. 28 by the respective arrows 120 (starting from P or E).

A further alternative consists in that the transition from the sleep state S of the processor takes place directly in the (one) active state A of the transmitter. The advantage of this solution is that it is immediately indicated to the user that the sleep state has been exited since the lamp 1 lights up in the active state A. In the diagram of FIG. 28, the arrow 101 would then not be connected to P but to A.

Another alternative is illustrated in FIG. 13b. In one embodiment, the lamp 1 can have a connection 8 for wired charging of the rechargeable battery 6 (e.g., a USB-C socket). After plugging in a plug 9 (e.g., a USB-C plug) into the connection 8 and connecting to a power source for a predetermined time interval (e.g., 2 seconds) the charging circuit 9 recognizes the coupling to the power source. As a result, similarly to the inductive coupling, the processor 2.2 and the sensor module 2.1 are switched on (activated) and the transmitter is transferred into the passive state P (central image of FIG. 13.b). The transmitter of the lamp 1 can then go over into the active state A by means of a rapid tilting movement and thus light up (see the right-hand diagram in FIG. 13b). Similarly to the inductive coupling, here too a transition from the sleep state S of the processor can take place directly into the active state A of the transmitter. A similar mode of operation can also be implemented for the capacitive coupling. Furthermore, other connections and appurtenant plugs can also be used for wired charging or the transition from the sleep mode S of the processor to the passive state P (or the active state A) of the transmitter.

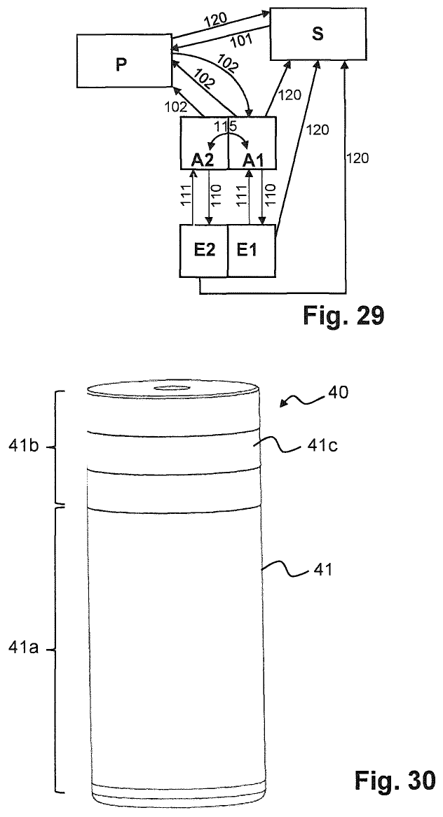

FIG. 29 shows a further embodiment of the control of the lamp according to the invention. In this embodiment, the active state of the transmitter has a first mode A1 and a second mode A2. Similarly, a first setting state mode E1 and a second setting state mode E2 are provided for the setting state of the transmitter. A configuration with further modes is possible. In the first setting state mode E1, for example, the intensity of the electromagnetic radiation can be set (dimming) and in the second setting state mode E2, for example, the color temperature. In principle, the controller works similarly to the controller shown in FIG. 28. The user can enter into the sleep mode S of the processor by shaking (arrow 120) from any other state (P, A1, A2, E1, E2). A transition from the sleep mode S into the active mode of the processor and the passive state P of the transmitter can take place by means of coupling detection (inductive, capacitive, wired electrical) (arrow 101). From there, by rapid tilting, the user enters into the first mode of the active state A1 of the transmitter, but not into the second mode of the active state A2 (see curved arrow 102). From any mode of the active state A1, A2, a transition into the passive state P of the transmitter is achieved by rapid tilting (straight arrows 102). From the first mode of the active state A1, the user can enter into the setting state mode of the transmitter E1 (dimming) by slowly tilting (arrow 110). The dimming E1 is ended by returning to the rest position (arrow 111) and the transmitter is again located in the first mode of the active state A1. The color temperature is set in the second setting state mode E2 by slowly tilting (arrow 110) from the second mode of the active state. The second mode of the active state A2 is reached again by returning into the rest position (arrow 111). It is possible to jump to and fro between the modes A1 and A2 of the active state of the transmitter by rapid double-tilting (double arrow 115). In addition, in one embodiment, a resetting from the second mode of the active state A2 into the first mode A1 can be accomplished after a predetermined time interval (e.g., 30 seconds) has elapsed in which no change in color temperature was made.

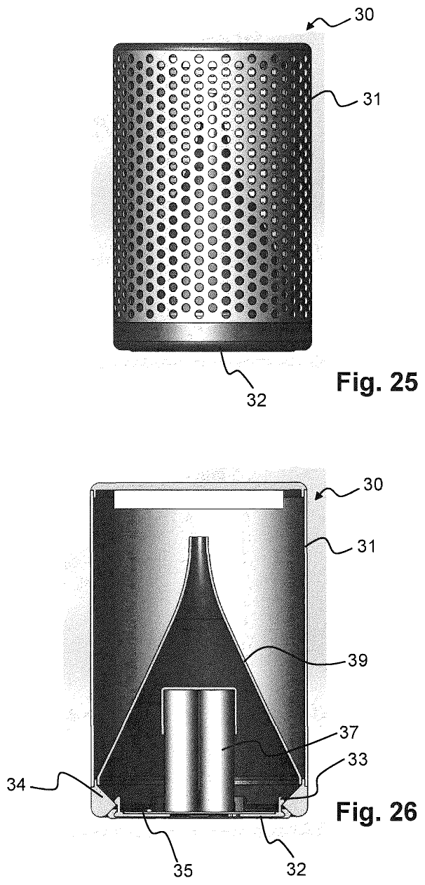

Further reference is made to FIGS. 24 to 26 which show an apparatus in the form of a playback device for sound waves (e.g., radio or MP3 player or the like.) 30 show. The playback device has a housing 31 and a bottom plate 32, wherein the bottom plate 32 serves as a stand. As the longitudinal section in FIG. 26 shows, the playback device 30 has a circuit board 35 and rechargeable batteries 36 within the perforated housing 31, which are supported by the bottom plate 32. Various loudspeakers 39 are also provided, which represent the transmitters in the sense of the present invention. The bottom plate 32 has snap hooks 33 on the side, which snap into place behind corresponding projections 34 on the lower end of the housing 31 in an appropriate arrangement. In this way, the bottom plate 32 is fixed to the housing 31. The playback device 30 works similarly to the lamp 1, wherein the states and the transitions between the states of the lamp 1 are shown in detail above. Instead of the intensity/brightness of the electromagnetic radiation of the lamp, the sound pressure level of the loudspeakers can be controlled in a first setting state mode. Similarly to the light color of the lamp, a piece of music can be selected for playback in a second setting state mode.

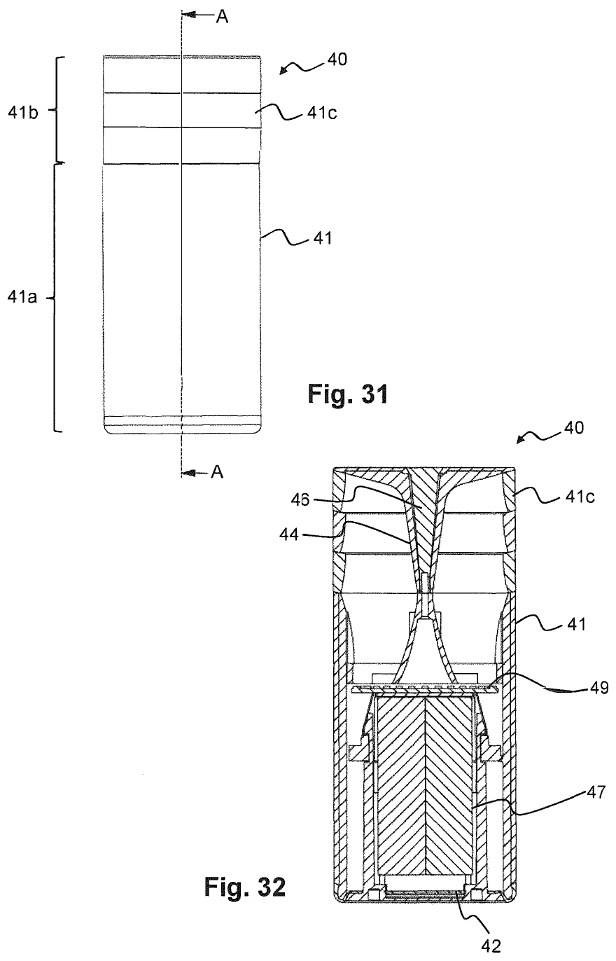

A further exemplary embodiment of a device 40 according to the invention, which represents a lamp, is shown in FIGS. 30 to 32. Accordingly, the transmitter comprises illuminants, wherein the illuminants bring about an emission of light from the cylindrical lamp both laterally outwards and also upwards.

The lamp 40 shown in FIGS. 30 and 32 has a hollow-cylindrical housing 41 which is closed in a first section 41a and in a second section 41b has annular lenses 41c running around in a circular shape, through which the light emitted by the LEDs lying on an LED ring 49 can pass to the outside. The light from the LEDs of the LED ring 49 in the housing 41 is reflected by a reflector 44 in a radial direction relative to the longitudinal axis of the housing 41 so that it can emerge from the housing 41 via the annular lenses 41c. The device also has a bottom plate 42 with the processor of the control module, an induction coil for wireless charging of the rechargeable battery 47 and a holder for the rechargeable battery 47. The LEDs of the LED ring 49 arranged above the rechargeable battery 47 are connected to the processor. The light emitted by this/these LED(s) is also emitted upwards along a translucent logo column 46 arranged in the reflector 44 in the direction of the longitudinal axis of the housing 41. By this means, a column of light emerging upwards from the housing 41 is achieved, which in one exemplary embodiment can light up in the form of a brand logo.

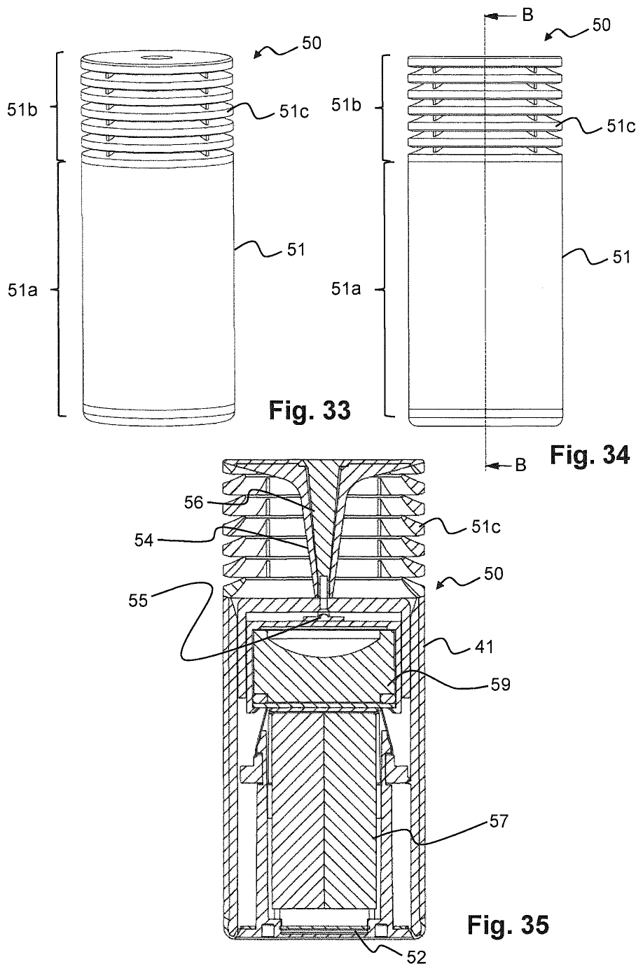

A further exemplary embodiment of a device in the form of a playback device 50 is shown in FIGS. 33 to 35. In this playback device, both loudspeakers and illuminants are controlled as transmitters by a processor.

The playback device shown in FIGS. 33 and 35 has a hollow-cylindrical housing 51, which is closed in a first section 51a and in a second section 51b has acoustic lamellae 51c running around in a circle, which represent openings in the housing through which sound waves generated by the internal loudspeakers 59 can pass to the outside. The sound waves are reflected in the housing 51 by a reflector 54 in a radial direction relative to the longitudinal axis of the housing 51, so that they can emerge from the housing 51 via the lamellae 51c. The device also has a bottom plate 52 with the processor of the control module and an induction coil for wireless charging the rechargeable battery 57. Furthermore, an illuminant 55 is provided in the form of an LED or a plurality of LEDs, which are connected to the processor. The light emitted by this/these LED(s) is emitted upwards along a translucent logo column 56 arranged in the reflector 54 in the direction of the longitudinal axis of the device 50. In this way, a column of light emerging from the housing 51 is achieved, which in one exemplary embodiment lights up in the form of a brand logo. Alternatively or additionally, the illuminant 55 can display the status of the device 50. The device 50 represents a combined playback device with a lighting function. The transmitter comprises at least one loudspeaker 59 and at least one illuminant 55, which are each arranged inside the housing 51. In addition, such a playback device can have additional lamps that illuminate the housing from the inside, for example the lamellae, so that colored, translucent lamellae give the impression of a lighting or glowing.

Such a combined device can be configured in such a manner that the processor controls the lighting means and the loudspeakers of the transmitter independently of one another. In this exemplary embodiment, the method of operation of the processor explained above can be used, in which the transitions of the transmitter from the passive state into a first active state and further into at least one second active state (e.g., the transitions between the above-described first active state and the second, third, fourth and fifth active state) and back to the passive state can be performed in a particular, predetermined order.

In a further exemplary embodiment, the detection of a tilting movement of a device illustrated or described above in the form of a lamp or a playback device or a combination of both devices can be carried out from a tilted position. The operating mode is explained hereinafter using a device that is a lamp, for example a table lamp. The operating mode can be transferred similarly to a device with a playback device or a combined device. The tilted position differs, for example, from the rest position (in the rest position, the lamp is in a predetermined standing position on the table) by an angle of inclination of 30° (starting inclination angle). For example, the lamp is initially tilted from the rest position by the starting angle of inclination relative to a z-axis into the tilted position. In the rest position, for example, the z-axis runs approximately in the vertical direction. After this tilted position of the inclination sensor has been detected (i.e., reaching the starting inclination angle was detected), the transmitter goes over from the passive state into the active state (is turned on) when the lamp and the inclination sensor arranged in it is moved back into the rest position with a rapid tilting movement (i.e., a predetermined final inclination angle is rapidly reached).

Here, the starting angle of inclination relative to the z-axis greater than the final inclination angle (for example, at least 5° greater), which is 10°, for example. The switching on of the illuminant of the lamp (i.e., the transition to the active state) is performed in such a manner that the set brightness and color temperature of the illuminant corresponds to the setting during the last lighting process. The transition from the active state into the passive state of the transmitter takes place similarly. Furthermore, a setting mode for the brightness can be reached by moving the lamp and thus the inclination sensor into the above-specified tilted position in an active state of the transmitter and then holding the lamp in this position (i.e., only a slow tilting movement is carried out in the tilted position). Dimming begins after a predetermined holding time in the tilted position (during this time, the lamp does not fall below the predetermined final angle of inclination and the inclination sensor only detects a small change in the angle of inclination) and is stopped when the lamp is tilted back into the rest position (the lamp position falls below the predetermined final angle of inclination). From the tilted position, with a subsequent rapid change in the angle of inclination back into the rest position, either the illuminant can be switched on or off, or with a subsequent slow change in the angle of inclination, a transition into a setting state (dimming) can be brought about.

In a further exemplary embodiment, in addition to the procedure explained in the previous paragraph, a transition from the passive state into the active state can take place if a slow tilting movement starting from the rest position is detected by the processor. For this purpose, the acceleration acting on the sensor is recorded constantly, i.e., at predetermined time intervals (e.g., every 500 ms) in the passive and active states by means of an acceleration sensor as an inclination sensor, which detects the acceleration in the direction of a z-axis. The measured acceleration is stored over a predetermined time interval, which comprises multiples of the specified time intervals, e.g., by means of a FIFO buffer. When a trigger inclination angle is exceeded, the processor determines whether the device has been tilted rapidly or slowly in the previous predetermined time interval. The processor determines this by analyzing the accelerations in the direction of the z-axis stored for the predetermined time interval. In the case of large accelerations at the comparatively small angles of inclination, it can be assumed that the change in the angle of inclination took place rapidly over the time interval and correspondingly with small, measured accelerations, that the change in the angle of inclination over the time interval was slow. In this exemplary embodiment, the transition into the active state takes place when a slow change in the angle of inclination has taken place (for example above a threshold value for the acceleration which must not be exceeded in the time interval). Thus, if the device is slowly tilted over a predetermined trigger inclination angle (e.g., 10°) the transition from the passive into the active state of the transmitter takes place, for example, in the case of a lamp this lights up with a minimum intensity of the emitted light of the illuminant. In the case of a lamp, in one exemplary embodiment, this can be immediately followed by a dimming process in which the brightness is increased slowly, in predetermined steps. The dimming can be terminated, for example, when the acceleration sensor detects a resetting of the lamp into the rest position. The lamp then lights up with the intensity that was set immediately before detection of the position. In the exemplary embodiment, the trigger inclination angle is significantly smaller than the starting angle of inclination.

In a further exemplary embodiment with several active modes (e.g., the modes A1 and A2 of the active state described above) it is possible to jump to and fro between these modes whereby over a very long-time interval (e.g. 8 seconds) a small change in the inclination angle relative to the tilted position explained above is detected (corresponds to a very long holding in the tilted position).

In the exemplary embodiment illustrated in FIG. 1b, the device has a lamp 1′ as a transmitter unit and a separate control module 2′ in the form of a cuboid. The control module 2′ comprises a processor, an inclination sensor fastened firmly to the control module 2′ and an acceleration sensor connected fixedly to the control module 2′. The methods described above for the one-part device can be implemented similarly with the two-part device, wherein the control module 2′ now performs the aforementioned tilting movements instead of the lamp 1′. The lamp 1′ does not move during the tilting movement of the control module 2′. For example, the lamp 1′ can go over from a passive state into the active state from a tilted position back into the rest position in relation to the z-axis (see axis 2A′ in FIG. 1b) by means of the rapid tilting movement of the control module 2′ described above, whereby the illuminants of the lamp 1′ are switched on. For this purpose, the processor of the control module 2′ sends a corresponding control signal to the lamp 1′, which accordingly receives this control signal.

The cuboid of the control module 2′ has side surfaces of different colors. As a result, different tilting directions are displayed for the user. If the control module 2′ is tilted in the direction of the first two opposite side surfaces (arrow 1C), a tilting movement is implemented in a first mode of the active state of the lamp 1′ as described above (e.g. to change the brightness of the illuminant of the lamp 1′), whilst the control module 2′ is tilted in the direction of the second two, opposite side surfaces (arrow 1D) in order to achieve a tilting movement in a second mode of the active state as above described (e.g. to change the light color). The distinction between the two tilting directions (arrows 1C and 1D) is achieved by providing a further acceleration sensor which also records the acceleration in relation to a y-axis (see axis 2B′ in FIG. 1b), which is perpendicular to the z-axis (axis 2A′ in FIG. 1b) of the rest position. The tilting movement in the direction of arrow 1C runs along the y-axis, whilst the tilting movement in the direction of arrow 1D runs perpendicular to the y-axis.

The device according to the invention enables a simple, intuitive and reliable control without pushbuttons or switches that are unattractive from an aesthetic point of view. Openings for charging the rechargeable battery are also not necessary, but can be provided in embodiments. The device according to the invention can also be sealed in such a manner that it can also be used outdoors. The solution according to the invention can be used, for example, for a device having a size or weight that can be carried or moved by a user. In the variant in which the control module is configured separately from the transmitter unit, other non-movable devices (e.g., wall lights) can be controlled by the method presented above.

The systems and devices described herein may include a controller, control unit, controlling means, system control, processor or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems for detecting skew in a wing slat of an aircraft described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-22. (canceled)

23. A device for emitting at least one of electromagnetic radiation or sound waves by a corresponding transmitter, comprising:
a control module connected to the transmitter,
wherein the control module comprises a processor and an inclination sensor,
wherein the inclination sensor is electrically connected to the processor,
wherein the processor is configured to evaluate at least one of an inclination angle or a change in inclination angle recorded by the inclination sensor continuously or periodically after each elapsing of a time interval in relation to a movement of the inclination sensor and uses the at least one of the inclination angle or change in inclination angle to control the transmitter in an active state, in which the transmitter is switched on, or in a passive state, in which the transmitter is switched off, such that
the processor controls the transmitter when ascertaining a tilting movement of the inclination sensor from a rest position or from a position tilted in relation to the rest position with a first change in inclination angle over a first tilting time interval in such a manner that the transmitter switches from an active state into a setting state, wherein in the setting state, at least one setting variable of the transmitter can be changed by the processor in accordance with a predetermined manner of change, or goes over into a further active state, wherein in the further active state, an operating mode of the transmitter is changed in relation to at least one setting variable compared to the active state, and
the processor, when ascertaining a tilting movement of the inclination sensor from the rest position or from a tilted position with a second change in inclination angle over the first tilting time interval, controls the transmitter in such a manner that the transmitter switches from the active state or the further active state into a passive state or from the passive state into the active state, wherein the second change in inclination angle differs from the first change in inclination angle.

24. The device according to claim 23, wherein the device comprises a lamp and the transmitter comprises at least one illuminant, with which one or more of an intensity, or a frequency or a frequency interval, or a color temperature of the electromagnetic radiation emitted by the at least one illuminant can be changed as a setting variable.

25. The device according to claim 23, wherein the device comprises a playback device and the transmitter comprises at least one loudspeaker, in which at least one of a sound pressure level emitted by the at least one loudspeaker or a selection of a piece of music for playback can be changed.

26. The device according to claim 23, wherein the active state has at least a first mode and a second mode and the setting state has at least a first mode and a second mode,
wherein the processor, when ascertaining a tilting movement of the inclination sensor from the rest position or from the tilted position with a first change in inclination angle over a first tilting time interval, controls the transmitter in such a manner that the transmitter switches from the first mode of the active state to the first setting state mode, in which at least one first setting variable can be changed in accordance with a first predetermined manner of change, and
wherein the processor, when ascertaining a tilting movement of the inclination sensor from the rest position or from the tilted position with a first change in inclination angle over a first tilting time interval, controls the transmitter in such a manner that the transmitter switches from the second mode of the active state into the second setting state mode, in which at least one second setting variable can be changed according to a second predetermined manner of change,
wherein at least one of
the at least a second setting variable differs from the at least one first setting variable, or
the second predetermined manner of change of the at least one second setting variable differs from the first predetermined manner of change of the at least one first setting variable,
wherein at least one of
the processor when ascertaining a double tilting movement of the inclination sensor in quick succession from the rest position or the tilted position, controls the transmitter in such a manner that the transmitter switches from the first mode of the active state into the second mode of the active state or conversely, depending on which mode was adopted by the transmitter before the double tilting movement, or
when ascertaining a tilting movement of the inclination sensor from the rest position or from the tilted position with a third change of inclination angle over the first tilting time interval, the processor controls the transmitter in such a manner that the transmitter switches from the first mode of the active state into the second mode of the active state or conversely, depending on which mode was adopted by the transmitter prior to this tilting movement, wherein the third change in inclination angle differs from the first change in inclination angle and the second change in inclination angle.

27. The device according to claim 26, wherein the processor controls the transmitter in such a manner that after a transition from the passive state into the active state initially the first mode of the active state is adopted.

28. The device according to claim 26, wherein the processor is configured to control the transmitter in such a manner that, after expiry of a predetermined time interval in the second mode of the active state the transmitter automatically switches into the first mode of the active state without going into the second mode of the setting state.

29. The device according to claim 26, wherein the processor is configured to control the transmitter in such a manner that in the setting state or in the first setting state mode and in the second setting state mode the transmitter changes the at least one setting variable or the at least one first setting variable and the at least one second setting variable according to the predetermined manner of change or according to the predetermined first manner of change and the predetermined second manner of change until the inclination sensor has tilted into a lower limiting position, in which an angle of inclination at or below a final angle of inclination relative to the rest position is reached.

30. The device according to claim 23, further comprising a rechargeable storage element configured to supply the device with electrical energy, which is one of
supplied by a charging unit via wireless energy transmission via inductive or capacitive coupling, or
chargeable by wired energy transmission via an electrical coupling.

31. The device according to claim 30,
wherein the device has a sleep state in which a consumption of electrical energy in the processor is limited to a minimum value and the transmitter is switched off,
wherein the processor is configured to switch the transmitter from the sleep state into an active state when a coupling of the device to the charging unit is detected.

32. The device according to claim 23, wherein the processor is configured to effect a transition from the active state into the sleep state if the inclination sensor detects a shaking movement within a predetermined time interval or the processor determines a tilting movement of the inclination sensor from the rest position or from the tilted position with a fourth change in inclination angle over a second tilting time interval, wherein the fourth change in inclination angle is greater than the first change in inclination angle and then the second change in inclination angle.

33. The device according to claim 23,
wherein the control module additionally has an acceleration sensor which is electrically connected to the processor and movable with the inclination sensor,
wherein the processor is configured to evaluate at least one of an acceleration or change in acceleration detected by the acceleration sensor continuously or periodically after each elapsing of at least one time interval and additionally uses the at least one of the acceleration or change in acceleration to control the transmitter,
wherein the additional acceleration sensor is configured to evaluate the at least one of the acceleration or change in acceleration in a direction that differs from a direction of the rest position,
wherein the direction of the rest position is a direction which is substantially vertical in the rest position of the inclination sensor.

34. The device according to claim 23,
wherein the transmitter is arranged in at least one transmitter unit that is spatially separate from the control module,
wherein each transmitter unit comprises a transmitter and at least one of a housing or a holder,
wherein the transmitter is arranged in or on the at least one of the housing or the holder,
wherein the control module with the inclination sensor is movable separately from the transmitter unit,
wherein the control module is configured to transmit and each transmitter unit is configured to receive control signals from the processor via a communication channel, through which the transmitter can be controlled by the processor.

35. The device according to claim 23,
wherein the transmitter and the control module have at least one of a common housing or a common holder,
wherein the transmitter and the control module are arranged in or on the at least one of the housing or the holder.

36. A control module for use in controlling a transmitter that emits at least one of electromagnetic radiation or sound waves, comprising:
the control module configured to be connectable to the transmitter,
wherein the control module comprises a processor and an inclination sensor,
wherein the inclination sensor is electrically connected to the processor,
wherein the processor is configured to evaluate at least one of an inclination angle or a change in inclination angle recorded by the inclination sensor continuously or periodically after each elapsing of a time interval in relation to a movement of the inclination sensor and uses the at least one of the inclination angle or change in inclination angle to control the transmitter in an active state, in which the transmitter is switched on, or in a passive state, in which the transmitter is switched off, such that
the processor controls the transmitter when ascertaining a tilting movement of the inclination sensor from a rest position or from a position tilted in relation to the rest position with a first change in inclination angle over a first tilting time interval in such a manner that the transmitter switches from an active state into a setting state, wherein in the setting state, at least one setting variable of the transmitter can be changed by the processor in accordance with a predetermined manner of change, or goes over into a further active state, wherein in the further active state, an operating mode of the transmitter is changed in relation to at least one setting variable compared to the active state, and
the processor, when ascertaining a tilting movement of the inclination sensor from the rest position or from a tilted position with a second change in inclination angle over the first tilting time interval, controls the transmitter in such a manner that the transmitter switches from the active state or the further active state into a passive state or from the passive state into the active state, wherein the second change in inclination angle differs from the first change in inclination angle.

37. A method for controlling a transmitter of a device according to claim 23, comprising the following steps:
continuous or periodical, after each elapsing of at least one time interval, recording of at least one of an inclination angle data or a change in inclination angle data in relation to a movement of the inclination sensor by the inclination sensor,
evaluating the at least one of the recorded inclination angle data or the recorded change in inclination angle data and using the evaluated data for controlling the transmitter in an active state, in which the transmitter is switched on, or in a passive state, in which the transmitter is switched off, in such a manner
that the processor, when ascertaining a tilting movement of the inclination sensor from a rest position or from a tilted position in relation to a rest position with a first change of inclination angle over a first tilting time interval controls the transmitter in such a manner that the transmitter switches from an active state into a setting state, wherein in the setting state, at least one setting variable of the transmitter can be changed by the processor according to a predetermined manner of change or switches into a further active state, wherein in the further active state, an operating mode of the transmitter in relation to at least one setting variable is changed compared to the active state, and
that the processor when ascertaining a tilting movement of the inclination sensor from the rest position or from the tilted position with a second change in inclination angle over the first tilting time interval controls the transmitter in such a manner that the transmitter switches from the active state or the further active state into the passive state or switches from the passive state into the active state, wherein the second change in inclination angle differs from the first change in inclination angle.

38. The method according to claim 37,
wherein the active state has at least a first mode and a second mode and the setting state has at least a first mode and a second mode,
wherein the processor, when ascertaining a tilting movement of the inclination sensor from the rest position or from the tilted position with a first change in inclination angle over a first tilting time interval, controls the transmitter in such a manner that the transmitter switches from the first mode of the active state to the first setting state mode, in which at least one first setting variable can be changed in accordance with a first predetermined manner of change, and
wherein the processor, when ascertaining a tilting movement of the inclination sensor from the rest position or from the tilted position with a first change in inclination angle over a first tilting time interval controls the transmitter in such a manner that the transmitter switches from the second mode of the active state into the second setting state mode, in which at least one second setting variable can be changed according to a second predetermined manner of change, wherein at least one of
the at least one second setting variable differs from the at least one first setting variable, or
the second predetermined manner of change of the at least one second setting variable differs from the first predetermined manner of change of the at least one first setting variable,
wherein at least one of
the processor, when ascertaining a double tilting movement of the inclination sensor in quick succession from the rest position or the tilted position, controls the transmitter in such a manner that the transmitter switches from the first mode of the active state into the second mode of the active state or conversely, depending on which mode was adopted by the transmitter before the double tilting movement, or
when ascertaining a tilting movement of the inclination sensor from the rest position or from the tilted position with a third change of inclination angle over the first tilting time interval, the processor controls the transmitter in such a manner that the transmitter switches from the first mode of the active state into the second mode of the active state or conversely, depending on which mode was adopted by the transmitter prior to this tilting movement, wherein the third change in inclination angle differs from the first change in inclination angle and the second change in inclination angle.

39. The method according to claim 38, wherein the processor controls the transmitter in such a manner that after the transition of the processor from the passive state into the active state, the first mode of the active state is initially adopted.

40. The method according to claim 38, wherein the processor controls the transmitter in such a manner that after a time interval in the second mode of the active state has elapsed, the transmitter automatically switches into the first mode of the active state without going into the second setting state mode.

41. The method according to claim 38, wherein the processor controls the transmitter in such a manner that in the setting state or in the first setting state mode and in the second setting state mode, the at least one first setting variable or the at least one first setting variable and the at least one second setting variable changes according to the predetermined manner of change or according to the predetermined first manner of change and the predetermined second manner of change until the inclination sensor is tilted into a lower limiting position in which an inclination angle is reached at or below a final inclination angle relative to the rest position.

42. The method according to claim 37,
wherein the device has a sleep state in which a consumption of electrical energy in the processor is limited to a minimum value and the transmitter is switched off,
wherein the processor switches from the sleep state into an active state when a coupling of the device to a charging unit is detected.

43. The method according to claim 37, wherein a transition of the processor from the active state into the sleep state is brought about when the inclination sensor detects a shaking movement in a predetermined time interval or the processor detects a tilting movement from the rest position or from the tilted position with a fourth change in inclination angle over a second tilting time interval, wherein the fourth change in inclination angle is greater than the first change in inclination angle and greater than the second change in inclination angle.

44. The method according to claim 37,
wherein an acceleration sensor is additionally provided which is electrically connected to the processor and can be moved with the inclination sensor,
wherein the processor evaluates at least one of an acceleration or change in acceleration detected by the acceleration sensor continuously or periodically after each elapsing of at least one time interval and additionally uses the at least one of the acceleration or the change in acceleration to control the transmitter,
wherein the additional acceleration sensor evaluates the at least one of the acceleration or the change in acceleration in a direction that differs from a direction of the rest position, and
wherein the direction of the rest position is a direction which is substantially vertical in the rest position of the inclination sensor.
